(19) United States
(12) Patent Application Publication
(10) Pub. No.: US 2006/0271332 A1
(43) Pub. Date: Nov. 30, 2006

(54) Method for calibrating a non-contact sensor using a robot

(75) Inventor: Hannes Loferer, Bad Endorf (DE)

Correspondence Address: HARNESS, DICKEY & PIERCE, P.L.C., P.O. BOX 828, BLOOMFIELD HILLS, MI, 48303, US

(73) Assignee: Perceptron, Inc.

(21) Appl. No.: 11/389,600

(22) Filed: Mar. 24, 2006

Related U.S. Application Data
(63) Continuation-in-part of application No. 11/131,610, filed on May 18, 2005, now Pat. No. 7,113,878.

(51) Int. Cl. G01C 17/00

(52) U.S. Cl. 702/150

(57) ABSTRACT

A method is provided for calibrating a non-contact sensor with respect to an external reference frame through the use of a robot associated with a manufacturing workstation. The method includes: identifying a target associated with the robot; capturing image data of the target by the non-contact sensor as the target is moved amongst six different measurement positions within a field of view of the non-contact sensor; capturing positional data for the robot as reported by the robot at the measurement positions, where the positional data for the robot is reported in the external reference frame; determining positional data for the target based in part on the image data, wherein the positional data is defined in a sensor reference frame associated with the non-contact sensor; and determining a transform between the sensor reference frame and the external reference frame based on the positional data for the target and the positional data for the robot.

### CROSS-REFERENCE TO RELATED APPLICATIONS

This application is a continuation-in-part of U.S. patent application Ser. No. 11/131,610 filed on May 18, 2005. The disclosure of the above application is incorporated herein by reference.

### FIELD

The present invention relates to non-contact gauging applications and, more particularly, to a method for calibrating a non-contact sensor with respect to an external reference frame through the use of a robot associated with a manufacturing workstation.

### BACKGROUND

Demand for higher quality has pressed manufacturers of mass produced articles, such as automotive vehicles, to employ automated manufacturing techniques that were unheard of when assembly line manufacturing was first conceived. Today, robotic equipment is used to assemble, weld, finish, gauge and test manufactured articles with a much higher degree of quality and precision than has been heretofore possible. Computer-aided manufacturing techniques allow designers to graphically conceptualize and design a new product on a computer workstation and the automated manufacturing process ensures that the design is faithfully carried out precisely according to specification. Machine vision is a key part of today's manufacturing environment. Machine vision systems are used in conjunction with computer-aided design systems and robotics to ensure high quality is achieved at the lowest practical cost.

Achieving high quality manufactured parts requires highly accurate, tightly calibrated machine vision sensors. Not only must a sensor have a suitable resolution to discern a manufactured feature of interest, the sensor must be accurately calibrated to a known frame of reference so that the feature of interest may be related to other features on the workpiece. Without accurate calibration, even the most sensitive, high resolution sensor will fail to produce high quality results.

In a typical manufacturing environment, there may be a plurality of different non-contact sensors, such as optical sensors, positioned at various predetermined locations within the manufacturing, gauging or testing station. The workpiece is placed at a predetermined, fixed location within the station, allowing various predetermined features of the workpiece to be examined by the sensors. Preferably, all of the sensors properly positioned and should be carefully calibrated with respect to some common fixed frame of reference, such as a common reference frame on the workpiece or at the workstation.

It is also envisioned that the non-contact sensors and their associated mounting structures may get bumped or jarred, thereby throwing the sensor out of alignment. From time to time, a sensor also needs to be replaced, almost certainly requiring reorienting and recalibrating. Thus, sensor positioning, alignment and calibration is a fact of life in the typical manufacturing environment.

Therefore, it is desirable to provide a quick and efficient technique for calibrating such non-contact sensors. The statements in this section merely provide background information related to the present disclosure and may not constitute prior art.

### SUMMARY

A method is provided for calibrating a non-contact sensor with respect to an external reference frame through the use of a robot associated with a manufacturing workstation. The method includes: identifying a target associated with the robot; capturing image data of the target by the non-contact sensor as the target is moved amongst six different measurement positions within a field of view of the non-contact sensor; capturing positional data for the robot as reported by the robot at the measurement positions, where the positional data for the robot is reported in the external reference frame; determining positional data for the target based in part on the image data, wherein the positional data is defined in a sensor reference frame associated with the non-contact sensor; and determining a transform between the sensor reference frame and the external reference frame based on the positional data for the target and the positional data for the robot.

In another aspect of the disclosure, a method is provided for determining a transform between positional data as reported by a robot residing in a manufacturing workstation and an external reference frame. The method includes: affixing a target to the robot in a manner such that position of the target is unknown in a base reference frame of the robot; moving the target to at least six measurement positions within a field of observation of a target calibration device; capturing positional data for the target by the target calibration device at each of the measurement positions, wherein the positional data for the target is defined in the external reference frame; capturing positional data for the robot as reported by the robot at each of the measurement positions, wherein the positional data for the robot is defined in the base reference frame associated with the robot; and determining a transform between the reference frame associated with the robot and the external reference frame based on the positional data for the target and the positional data for the robot.

Further areas of applicability will become apparent from the description provided herein. It should be understood that the description and specific examples are intended for purposes of illustration only and are not intended to limit the scope of the present disclosure.

### DRAWINGS

FIG. 1 is a diagram of an exemplary gauging workstation;

FIG. 2 is flowchart depicting a method for calibrating a non-contact sensor using a robot according to the present disclosure;

FIG. 3 is flowchart depicting a method for determining a transform between position data reported by the robot and a reference frame external to the robot;

FIG. 4 is a diagram illustrating an exemplary gauging station configured with a laser tracker calibration system;

### DETAILED DESCRIPTION

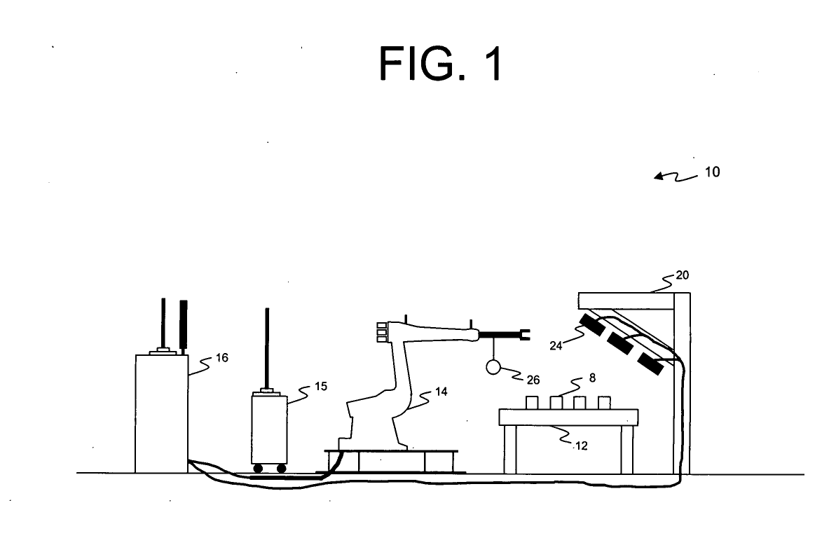

FIG. 1 illustrates an exemplary gauging workstation 10. In this example, workpieces 8 to be gauged at the gauging station 10 are placed on a fixture 12. A robot 14 positioned adjacent to the fixture 12 is operable to perform a manufacturing operation on the workpieces. The robot 14 may in turn be coupled to a robot controller 15 and/or a data processing unit residing in a control cabinet 16. It is readily understood that other types of gauging workstations are within the scope of this disclosure.

For gauging the workpiece, a sensor mounting frame 20 is also placed adjacent to the fixture, thereby providing mounting positions for a series of non-contact sensors 24-1 through 24-n. Each sensor is configured to project one or more planes of laser light towards the workpiece and capture image data which correlates to an intersection between the structured light and the surface of the workpiece. Image data may be translated to measurement data at the sensor or at a remote computer. In either case, data is sent from the sensor to the data processing unit for further processing and/or storage. This type of sensor is commonly referred to as a laser triangulation sensor. For further details regarding an exemplary sensor, reference may be had to the TriCam sensors manufactured by Perceptron Inc. of Plymouth, Mich. However, it is readily understood that other types of non-contact sensors are also with in the scope of the present invention.

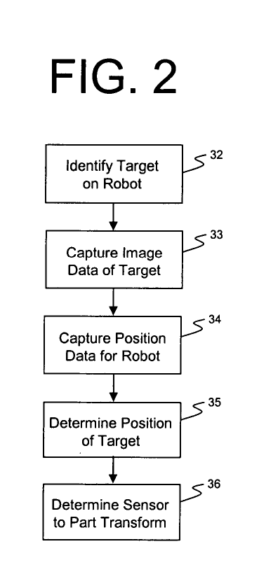

A method for calibrating a non-contact sensor with respect to a reference frame through the use of a robot is further described in relation to FIG. 2. The reference frame is preferably associated with the workpiece, the gauging station or some arbitrary coordinate system outside of the robot. This reference frame will be referred to herein as the external reference frame.

The sensor calibration process begins by identifying a measurement target on the robot at 32. In an exemplary embodiment, a sphere is attached to the robot to serve as the target. It is envisioned that an existing component of the robot may serve as the target. Likewise, it is envisioned that other types of targets may be affixed to the robot. In any case, it is assumed that precise dimensions of the target are known.

The target is then moved to at least six (and preferably eight) different measurement positions within the field of view of the sensor being calibrated. At each measurement position, the non-contact sensor captures image data at 33 for the target affixed to the robot. To improve accuracy, it has been found that the laser plane from the sensor should preferably intersect the sphere at a location between 50% and 85% of the sphere diameter. Coincidentally, positional data for the robot is reported at 34 by the robot at each of the measurement positions. It is assumed that the robot reports the positional information in relation to the external reference frame of interest.

The sensor is then calibrated by determining a transform between the sensor reference frame and the external reference frame at 36 using the captured positional data. Computations for determining the transform are executed by one or more software-implemented routines residing in the robot controller or the data processing unit. It is to be understood that only the relevant steps of the methodology are discussed below, but that other software-implemented instructions may be needed to control and manage the overall operation of the system.

First, positional data for the sphere in the sensor reference frame is derived from the captured image data. For example, points on the surface of the sphere may be determined from the image data. When the laser plane of the sensor intersects the sphere, the captured image data is in the form of an arc. From the image data, a center point is determined for the arc. Points on the surface of the sphere may be constructed by adding or subtracting the radius of the arc to or from the center point in the same plane in which the laser plane intersects the sphere. In this way, at least four points on the surface of the sphere can be derived from the image data.

Subtracting the points on the surface of the sphere from the center point of the sphere should equate to the known radius measure of the sphere. This relationship may be further defined as follows:
Radius of sphere=[tool-to-part transform]center of sphere in tool space−[sensor-to-part transform]points on surface of the sphere in sensor space
Given measured points on the surface sphere, a tool-to-part transform and the known radius of the sphere, the unknown center of the sphere in tool space and the unknown sensor-to-part transform of interest can be solved for using various optimization techniques. In an exemplary embodiment, a least squares technique is used to solve for the unknowns. However, it is understood that other techniques for solving the equations may be employed and thus are within the scope of this disclosure.

For illustration purposes, an exemplary computation for determining a transform between the sensor reference frame and an external reference frame is set forth in the Appendix below. It is understood that different representations of the transform may be used when performing this computation.

Positional data for the robot as reported by the robot at each of the measurement positions by definition provides a transform between a tool configured on the robot and some arbitrary reference frame external to the robot (referred to as tool-to-part transform). As described above, it was assumed that the robot reported positional information in the external reference frame of interest. However, since the robot is initially configured in relation to some arbitrary reference frame, it must be programmed to coincide with the external reference frame of interest.

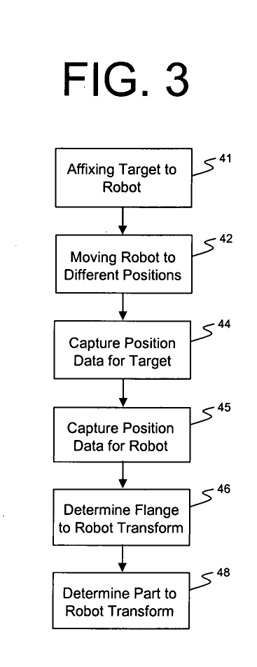

With reference to FIG. 3, a transform must be established between the positional data reported by the robot and the external reference frame before proceeding with the sensor calibration procedure described above. To do so, the robot is moved at 42 to at least six (and preferably eight) different measurement positions within the field of observation of a robot calibration device. At each measurement position, positional data for the robot is captured at 44 by the robot calibration device. Positional data for the robot is coincidentally reported at 45 by the robot at each of the measurement positions. This positional data is then used to derive the transform in a manner further described below.

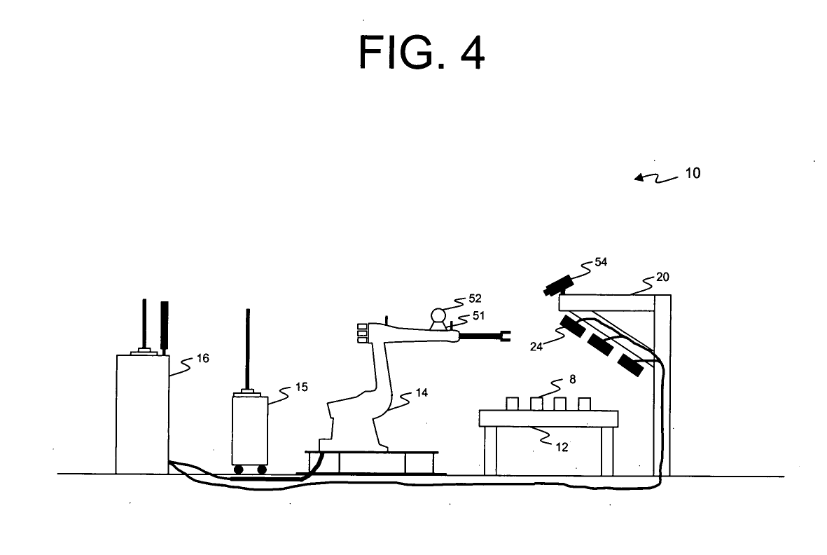

In an exemplary embodiment, the robot calibration device is a laser tracker as shown in FIG. 4. Briefly, a nesting station for a retroreflector is affixed to the robot. It should be noted that the position of the nesting station is unknown in relation to the reference frame of the robot. The laser tracker employs a servo drive mechanism with closed loop controller that points the laser tracker in the direction of a retroreflector. The retroreflector exhibits a reflective property, and thus will return an incoming beam of laser light towards the laser tracker. As long as the laser tracker is within the 45-60° field of view of the retroreflector, the laser tracker will precisely follow or track the position of the retroreflector. In this way, the laser tracker can capture positional data for the reflector affixed to the robot as it is moved amongst different measurement positions. The positional data is reported (or easily converted to) the external reference frame of interest. It is envisioned that other types of position capturing mechanisms are within the scope of this disclosure.

With continued reference to FIG. 3, the transform is derived from a relationship between the position of the retroreflector as defined in the external reference frame (also referred to as part space) and the position of the retroreflector relative to an end-effector of the robot (commonly referred to as the flange). Using a transform between the external reference frame and a base reference frame associated with the robot as well as a transform between an end-effector of the robot and the base reference frame of the robot, the position of the retroreflector in these two distinct spaces can be equated as follows:
[position of retroreflector in part space]=[robot-to-part][flange-to-robot][position of retroreflector in flange space].

Although position of the retroreflector in flange space is unknown, position of the retroreflector in part space is captured by the laser tracker. In addition, the transform between the end-effector and the base reference frame of the robot can be derived at 46 from the positional data reported by the robot as will be further described below. Given the position of the retroreflector in part space and the flange-to-robot transform, the remaining unknowns can be solved at 48 for using various optimization techniques. While the objective is to determine the unknown part-to-robot transform, determining the position of the retroreflector is a by-product of this process. In an exemplary embodiment, a least squares technique is used to solve for the unknowns. However, it is understood that other techniques for deriving the transform may be employed and thus are within the scope of this disclosure.

Positional data for the robot as reported by the robot at each of the measurement positions by definition provides a transform between a tool configured on the robot and some arbitrary reference frame external to the robot (referred to as tool-to-part transform). Since this arbitrary reference frame does not coincide with the external reference frame of interest, it is not used as a reference point. However, the robot controller is pre-programmed to provide a transform between this arbitrary reference frame and the base reference frame of the robot (referred to as part-to-robot transform) as well as a second transform between the tool- and the end-effector of the robot (referred to as tool-to-flange transform). Using these two transforms, the flange-to-robot transform can be derived from the positional data reported by the robot. First, the tool-to-robot transform is computed by multiplying the tool-to-part transform by the part-to-robot transform. The tool-to-robot transform is then multiplied with an inverse of the tool-to-flange transform, thereby yielding a flange-to-robot transform.

For illustration purposes, an exemplary computation for determining a transform between the positional data reported by the robot and an external reference frame is set forth in the Appendix below.

The description of the invention is merely exemplary in nature and, thus, variations that do not depart from the gist of the invention are intended to be within the scope of the invention. Such variations are not to be regarded as a departure from the spirit and scope of the invention.

[image]

[image]

[image]

[image]

[image]

[image]

[image]

[image]

What is claimed is:

1. A method for calibrating a non-contact sensor with respect to an external reference frame through the use of a robot associated with a manufacturing workstation, comprising:
identifying a target associated with the robot;
capturing image data of the target by the non-contact sensor as the target is moved amongst six different measurement positions within a field of view of the non-contact sensor;
capturing positional data for the robot as reported by the robot at the measurement positions, where the positional data for the robot is reported in the external reference frame;
determining positional data for the target based in part on the image data, wherein the positional data is defined in a sensor reference frame associated with the non-contact sensor;
determining a transform between the sensor reference frame and the external reference frame based on the positional data for the target and the positional data for the robot.

2. The method of claim 1 further comprises capturing positional data for the target coincidental with capturing position data for the robot.

3. The method of claim 1 further comprises affixing a sphere to the robot to serve as the target for the non-contact sensor.

4. The method of claim 1 further comprises deriving a tool-to-part transform between the positional data reported by the robot and the external reference frame and using the transform to program the robot to report positional data in the external reference frame.

5. The method of claim 1 further comprises determining
determining points on a surface of the sphere in the sensor reference frame using the image data of the target captured by the non-contact sensor;
determining points on a surface of the sphere in the external reference frame;
determining a center of the sphere in the external reference frame; and
subtracting the points on a surface of the sphere from the center of the sphere and equating to a known radius of the sphere.

6. The method of claim 5 wherein determining points on a surface of the sphere in the sensor reference frame further comprises determining a center of an arc formed by the image data and adding a radius measure to the center of the arc.

7. The method of claim 5 further comprises multiplying the points on a surface of the sphere in the sensor reference frame by an unknown transform between the sensor reference frame and the external reference frame; and multiplying an unknown center of the sphere in a reference frame associated with the tool by the tool-to-part transform.

8. The method of claim 7 further comprises solving for the unknowns using a least squares fit algorithm.

9. The method of claim 5 further comprises computing the transform between the sensor reference frame and the external reference frame in accordance with Eulers rotational theorem.

10. A method for determining a transform between positional data as reported by a robot residing in a manufacturing workstation and an external reference frame, comprising:
affixing a target to the robot in a manner such that position of the target is unknown in a base reference frame of the robot;
moving the target to at least six measurement positions within a field of observation of a target calibration device;
capturing positional data for the target by the target calibration device at each of the measurement positions, wherein the positional data for the target is defined in the external reference frame;
capturing positional data for the robot as reported by the robot at each of the measurement positions, wherein the positional data for the robot is defined in the base reference frame associated with the robot; and
determining a transform between the base reference frame associated with the robot and the external reference frame based on the positional data for the target and the positional data for the robot.

11 The method of claim 10 wherein capturing positional data for the target further comprises placing a retroreflector on a nesting station coupled to the robot and capturing positional data for the retroreflector using a laser tracker.

12. The method of claim 10 further comprises capturing positional data for the target coincidental with capturing positional data for the robot.

13. The method of claim 10 further comprises determining a flange-to-robot transform between an end-effector of the robot and the base reference frame of the robot based in part on the positional data captured by the robot.

14. The method of claim 13 further comprises
defining an unknown position of the target relative to the base reference frame of the robot using the flange-to-robot transform;
defining a mathematical function between the position data for the target as reported by the target calibration device and a product of unknown position of the target relative to the base reference frame of the robot with an unknown transform between the base reference frame of the robot and the external reference frame; and
solving for unknowns of the mathematical function to determine the transform between the base reference frame of the robot and the external reference frame.

15. The method of claim 10 further comprises deriving a tool-to-part transform between a tool configured on the robot and an arbitrary reference frame external to the robot based on the positional data captured by the robot.

16. The method of claim 15 further comprises computing a tool-to-robot transform by multiplying the tool-to-part transform with a part-to-robot transform between the arbitrary reference frame and the base reference frame of the robot, where the part-to-robot transform is given by the robot.

17. The method of claim 16 further comprises computing a flange-to-robot transform between an end-effector of the robot and the base reference frame of the robot by multiplying the tool-to-robot transform with an inverse of a tool-to-flange robot as given by the robot.

18. The method of claim 17 wherein determining a transform further comprises:
minimizing a distance between positional data for the target as defined in the external reference frame and a product of an unknown transform between the base reference frame of the robot and the external reference frame with flange-to-robot transform and with an unknown position of target relative to the end-effector of the robot; and
computing the transform between the base reference frame of the robot and the external reference frame in accordance with Eulers rotational theorem.
